(19) United States
(12) Patent Application Publication
(10) Pub. No.: US 2013/0032759 A1
(43) Pub. Date: Feb. 7, 2013

(54) NEAR INFRARED-EMITTING ER AND YB/ER DOPED CEF3 NANOPARTICULATES WITH NO VISIBLE UPCONVERSION

(71) Applicants: Richard E. Riman, Belle Mead, NJ (US); Mei-Chee Tan, Singapore (SG); Kumar A. Gangadharan, New Brunswick, NJ (US)

(72) Inventors: Richard E. Riman, Belle Mead, NJ (US); Mei-Chee Tan, Singapore (SG); Kumar A. Gangadharan, New Brunswick, NJ (US)

(73) Assignee: Rutgers, The State University of New Jersey, New Brunswick, NJ (US)

(21) Appl. No.: 13/466,079

(22) Filed: May 7, 2012

Related U.S. Application Data
(60) Provisional application No. 61/482,668, filed on May 5, 2011.

(51) Int. Cl. C09K 11/85; B82Y 30/00

(52) U.S. Cl. 252/301.36; 252/301.4 H; 977/773

(57) ABSTRACT

A rare earth element composition comprising CeF₃ particles doped with one or more rare earth elements selected from Pr, Nd, Yb, and Er, wherein each rare earth element atom replaces a Ce atom in said composition. The composition is optically transparent to wavelengths at which excitation, fluorescence or luminescence of the rare earth metals occur. Composite materials having dispersed therein the compositions, and luminescent devices incorporating the composite materials are also disclosed.

### CROSS-REFERENCE TO RELATED APPLICATIONS

This application claims the benefit of U.S. Provisional Application Ser. No. 61/482,668, filed May 5, 2011, which is hereby incorporated by reference. This application is also related to the PCT Application, which lists Dominik J. Naczynski, Mei-Chee Tan, Richard E. Reiman, Charles Roth, and Prabhas V. Moghe as inventors, entitled “MULTIFUNCTIONAL INFRARED-EMITTING COMPOSITES,” filed on May 7, 2012, and claiming the benefit of priority under 35 U.S.C. §119(e) of U.S. Provisional Applications Ser. Nos. 61/483,128, filed on May 6, 2011, and 61/482,668, filed on May 5, 2011. The entire disclosures of the PCT Application and U.S. Provisional Application Ser. No. 61/483,128 are incorporated herein by reference.

### BACKGROUND

Infrared-emitting rare-earth doped materials have been extensively used in fiber amplifiers, solid-state lasers, telecommunications, optoelectronics and remote sensing applications. See U.S. Pat. No. 7,094,361 and U.S. Pat. No. 6,699,406, each of which are incorporated herein by reference. In addition, the recent advent of infrared optical imaging systems has expanded the biomedical applications for infrared-emitting rare-earth doped nanomaterials for diagnostics and deep tissue imaging. Optical transitions for rare-earth doped materials are governed mainly by radiative transitions between energy levels of 4 f electrons that are shielded by 5 s and 5 p electrons. The absorption and emission properties of rare-earth doped materials can be further tailored by controlling the local environment, such as site symmetry, crystal field strength and electron-phonon interaction strength of rare-earth dopants.

### SUMMARY OF THE INVENTION

In one aspect, the present invention is directed to a rare earth element composition having cerium fluoride (CeF₃) particles doped with one or more rare earth elements, wherein each rare earth element atom replaces a Ce atom in the composition. The one or more rare earth elements may be selected from Pr, Nd, Yb, and Er. In certain embodiments, the rare earth element doping concentration is up to about 5 mole percent. In another embodiment, the doping concentration is from about 0.5 to about 1.0 mole percent.

The composition may further include sensitizer atoms, wherein up to 60 mole percent of the Ce atoms are replaced with the sensitizer atoms. In a certain embodiment, the sensitizer atoms are Yb.

All polymorphs of CeF₃ are suitable for the present invention. Accordingly, the CeF₃ may have a hexagonal, tetragonal, or orthorhombic structure.

The particles may consist essentially of particles having a size between about 2 nm and about 100 microns. In other embodiments, the particles may have a size between about 5 nm and about 10 microns. In another embodiment, the particles may have a size between about 10 nm and about 1 micron. In yet another embodiment, the particles may have a size between about 10 nm and 500 nm.

In another aspect, the present invention is directed to an optically transparent composite material including a dispersion in a polymeric matrix of a rare earth element composition having nanosized particles of a rare earth element doped CeF₃. The polymeric matrix may be a fluoropolymer.

In yet another aspect, the present invention is directed to a luminescent device including an optical element formed from an optically transparent composite material including a dispersion in a polymeric matrix of the composition having nanosized particles of a rare earth element doped CeF₃. This luminescent device may be a zero-loss link, upconversion light source, standard light source, volumetric display, flat panel display, or a source operating in a wavelength-division-multiplexing scheme.

In certain embodiments, the composite material of the luminescent device includes a plurality of rare earth element compositions that upon excitation, fluorescence or luminescence emit a plurality of overlapping emission bands. In other embodiments, the composite material includes a plurality of rare earth element compositions that upon excitation, fluorescence or luminescence emit a plurality of separate and distinct emission bands.

Thus, provided are methods for preparing efficient phosphors with improved optical properties. Subsequently lesser quantity of phosphors would be needed to produce brighter fluorescence with the same excitation source or a lower power excitation source will be required to achieve similar emissions. These phosphors can also be used for several applications, including infra-red imaging, optical waveguides and amplifiers for sensors and communication, laser materials, biomarkers and solar energy. (See U.S. Pat. Nos. 7,094,361; 6,699,406; 6,039,894; 5,698,397; 5,541,012 and 5,455,489, the disclosures of all of which are incorporated by reference.)

### BRIEF DESCRIPTION OF THE DRAWINGS

FIG. 1 provides a schematic of electronic transition in (a) Er-doped fluorides, (b) CeF₃ doped with Er (CeF₃:Er), and (c) CeF₃ doped with Yb,Er (CeF₃:Yb,Er).

FIG. 2 shows TEM micrographs of CeF₃:Er (0.5 mol %), (a) as-synthesized and (b) heat treated at 400° C. for 1 hour.

FIG. 3 displays the XRD profiles of (a) as-synthesized and heat-treated CeF₃:Er, (b) as-synthesized CeF₃:Yb,Er and (c) heat-treated CeF₃:Yb,Er. YbF₃ peak positions are indicated by *.

FIG. 4 illustrates the measured emission from (a) as-synthesized CeF₃:Er, (b) heat treated CeF₃:Er, (c) as-synthesized CeF₃:Yb,Er, and (d) heat treated CeF₃:Yb,Er upon excitation at ˜975 nm.

FIG. 5 displays measured decay time and quantum efficiency for ˜1530 nm emission from heat treated (a) CeF₃:Er and (b) CeF₃:Yb,Er upon excitation at ˜975 nm.

FIG. 6 illustrates a schematic for enhanced infrared emission in CeF₃:Yb,Er phosphors.

### DETAILED DESCRIPTION OF THE INVENTION

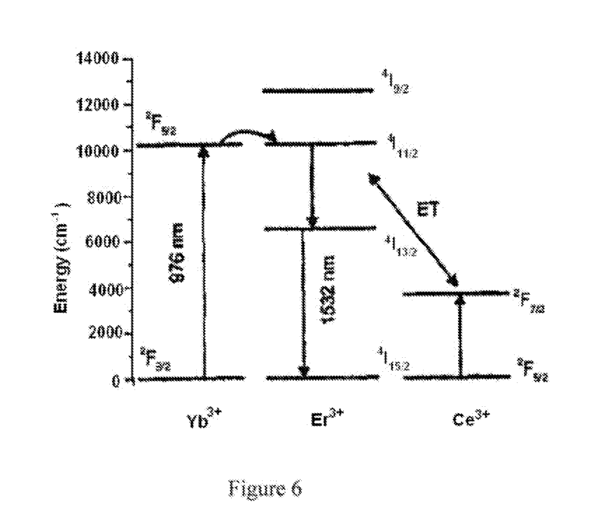

In one embodiment of the present invention, rare-earth element doped phosphor particles with intense infrared emissions are synthesized using the hydrothermal method disclosed by Wang, et al., Inorg. Chem., 45, 6661 (2006). Rare earth element doped phosphors generally consist of a host matrix, a luminescent center and a co-dopant (e.g., sensitizer). Low phonon energy halide hosts like fluorides are favored to reduce non-radiative losses. In this invention, the host also serves as a “sensitizer” to enhance energy transfer to the rare-earth luminescent center through the phonon-assisted energy transfer process. As shown in FIG. 6, this results in a significant increase in emission. In a preferred embodiment, this is demonstrated using cerium fluoride (CeF₃) as a host for rare-earth ions like Pr, Nd, Yb and Er.

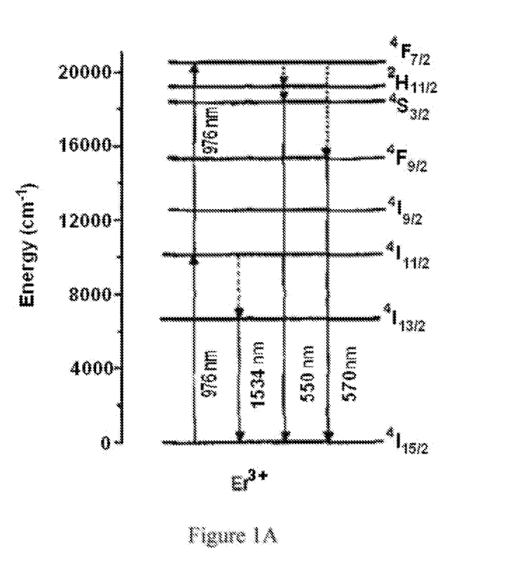

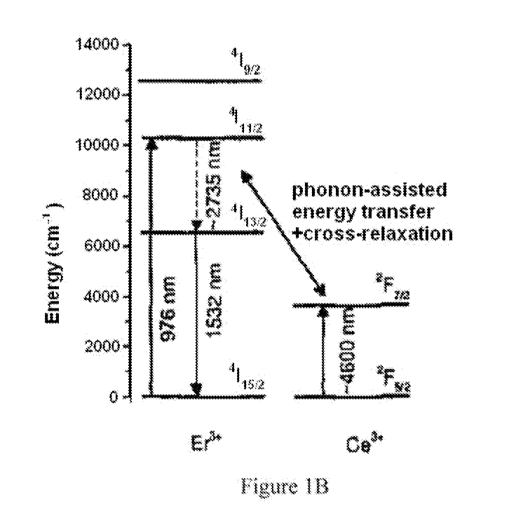

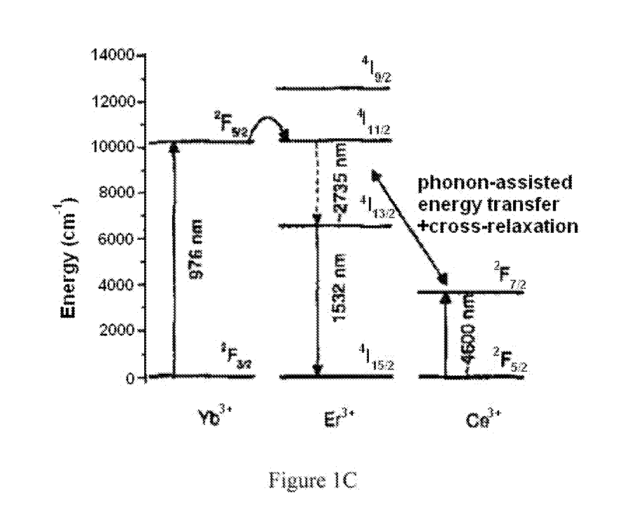

Er-doped materials with a broad ˜1530 nm emission are commonly used in optical communications, eye-safe measurements and spectroscopy. Together with the infrared emission at ˜1530 nm, upconversion upon excitation at ˜975 nm results in visible emissions (˜550 nm and ˜670 nm) from Er-doped materials (FIG. 1(a)). This near infrared-to-visible upconversion phenomenon observed in Er-doped materials reduces the intensity of the infrared emission at ˜1530 nm. Subsequently, the low branching ratio of ˜0.1-0.2 for the ˜1530 nm emission in Er fluoride glasses is a factor that limits its performance in commercial fiber amplifiers.

Efficiency improvements for the ˜1530 nm emission in Er-doped fluoride glasses are realized with Ce³⁺ and Yb³⁺ co-dopants. The branching ratio improves from ˜0.1-0.2 to ˜0.8-0.9 with Ce³⁺ co-doping, due to the phonon-assisted energy transfer between Er³⁺ and Ce³⁺ which facilitates the population of the ⁴I_{13/2} level and simultaneously decreases upconversion losses (FIG. 1 (b)). Furthermore, the ²F_{5/2} level of Yb³⁺ and ⁴I_{11/2} level of Er³⁺ are nearly similar in energy so that the high absorption cross section of Yb³⁺ further enhances energy transfer to Er³⁺ upon excitation at ˜975 nm (FIG. 1 (c)). Applicants have found that co-doping of Ce and Er can eliminate the near infrared-to-visible upconversion.

Accordingly, one embodiment of the present invention relates to the structural and optical characteristics of rare-earth doped particles synthesized by hydrothermal methods, preferably having a host material comprising an amount of CeF₃ effective to serve as a sensitizer, more preferably consisting essentially of CeF₃, and most preferably consisting of CeF₃. Additionally, all polymorphs of CeF₃ are suitable in forming the host material of the rare-earth doped particles of the present invention. Examples of suitable polymorph structures include, but are not limited to tysonite (hexagonal), tetragonal, and orthorhombic, of which the tysonite structure is preferred.

Essentially any of the known rare earth element dopants can be used. Preferred rare earth elements include Pr, Nd, Yb, Er, and combinations of these, with Er and Yb—Er being particularly preferred. In certain preferred embodiments, provided are Er- and Yb—Er-doped CeF₃ particles synthesized by hydrothermal methods. The rare earth element doped CeF₃ particles have the stoichiometric formula ReₓCe₁₋ₓF₃, wherein Re is a rare earth element, and x is the rare earth element doping concentration expressed in mole percent. The rare earth doping concentration can be as low as 1 ppb, and as high as the concentration where concentration or quantum quenching begins, which depends on both the host particle and the rare earth element, and can be as high as 60 mole percent (for example, Yb in CeF₃). The rate at which concentration quenching begins is readily determined by those skilled in the art. Preferably, the doping concentration ranges between about 1 ppm and about 5 mole percent. More preferably, the doping concentration ranges between about 1000 ppm and about 5 mole percent. Still more preferably, the doping concentration ranges between about 0.1 and about 3 mole percent. Most preferably, the doping concentration ranges between about 0.5 and about 1 mole percent.

In certain embodiments, the rare earth element doped CeF₃ particles can also include sensitizer atoms. Such particles have the stoichiometric formula ReₓSen_{y}Ce_{1-x-y}F₃, wherein Re is a rare earth element, and x is the rare earth element doping concentration expressed in mole percent, Sen is the sensitizer atom, and y is the sensitizer atom concentration expressed in mole percent. The sensitizer atom concentration can range from 0 to about 60 mole percent. An example of such sensitizer atoms includes, but is not limited to, Yb.

In one embodiment, these rare-earth element doped CeF₃ nanoparticles are synthesized by mixing stoichiometric amounts of rare-earth nitrates and ammonium fluoride in distilled water. Next, the mixture is transferred to a pressure vessel, where the reaction is allowed to continue at 200° C. for 2 h. Subsequently, the as-synthesized particles are separated and washed in distilled water by centrifugation.

In certain embodiments, further processing of the as-synthesized particles by heat treatment under a controlled environment can be performed to improve the particles' optical properties. For example, the as-synthesized particles may be heated using the double crucible method, where ˜0.9 g (inner crucible) and ˜3 g of ammonium bifluoride (outer crucible) are heated in a box furnace at 400° C. for 1 h.

The rare earth-containing particles have a crystallite particle size between about 2 nm and about 100 micrometers (microns), preferably between about 5 nm and about 10 micrometers, more preferably between about 10 nm and about 1 micrometer, most preferably between about 10 nm and 500 nm. For the purposes of the present invention, crystallite particle size refers to the size of the single crystal region of a particle, which can be a whole particle or a portion of a particle. Some particles, known as agglomerate or aggregate particles, may consist of multiple crystals. Nanoparticles according to the present invention are defined as having a dispersed particle size less than 100 nm. While active ion levels as high as 60 mole % can be attained, particles with parts per thousand, parts per million, or parts per billion active ion levels also have utility, in part because of the optical transparency of the composite materials.

Composite materials in which the nanosized particles of the present invention are dispersed in a matrix chemically inert thereto may be prepared by essentially conventional techniques. Dispersions in both glass and polycrystalline matrices can be prepared by sol-gel processes, as well as by conventional powder and melt techniques, and by solid and viscous sintering processes, in all of which the nanoparticles are processed with the matrix materials. Alternatively the nanoparticles may be precipitated into the matrix material by a variety of methods, such as crystallization in a glass, or primary or secondary crystallization in a polycrystalline matrix.

The matrix materials include glass, crystalline materials and polymeric materials. Inert, optically transparent liquids can also be used. Polymeric materials are preferred for their inertness toward active ion doped nanoparticles and their low processing temperatures. The matrix material should have excellent optical transparency at wavelengths at which excitation fluorescence or luminescence of the active ion occurs, and good film-forming characteristics. One type “optically transparent” composite materials according to the present invention have an attenuation of less than 100 dB/cm, preferably less than 10 dB/cm, and more preferably less than 1 dB/cm. Other properties will come into consideration, depending upon the particular end use requirements of the materials; however, these properties are well understood by those of ordinary skill in the art.

Examples of crystalline materials include yttrium oxide, aluminum oxynitride, and the like. Typically, host polymers for infrared wavelengths are fluoropolymers such as poly(vinylfluoride), poly(vinylidenefluoride), perfluorocyclobutyl polymers and copolymers, fluorinated polyimides, CYTOP amorphous fluoropolymers from Bellex International Corp. (Wilmington, Del.), TEFLON AF (an amorphous poly(vinylfluoride)), TEFLON PFA (a perfluoroalkoxy copolymer), and the like. Other suitable polymers include acrylates (such as PMMA), halogenated acrylates, benzo-cyclobutenes, poly-etherimides, siloxanes such as deuterated polysiloxanes, and the like.

The dispersion of nanosized particles into the matrix to form the composite should be performed at a temperature at which the inorganic nanoparticle remains a separate phase within the matrix, which is readily apparent to one of ordinary skill in the art.

In another embodiment of the present invention, a luminescent device is provided incorporating the composite material. Luminescent devices assembled from the composite materials of the present invention meet the need for articles with luminescent properties that are nanostructured so as not to interfere with the optical properties of the devices in which they are employed. Composite materials can be employed to produce a variety of useful articles with valuable optical properties. The composites can be readily processed by conventional techniques to yield optical fibers, bulk optics, films, monoliths, and the like. Optical applications thus include the use of the composite materials to form the elements of zero-loss links, upconversion light sources, standard light sources, volumetric displays, flat-panel displays, sources operating in wavelength-division-multiplexing schemes and the like. The present invention also includes biomedical diagnostic and bioassay systems, including deep tissue imaging, involving infrared-emitting rare-earth doped nanomaterials as described here.

The following non-limiting examples set forth below illustrate certain aspects of the invention. All parts and percentages are molar unless otherwise noted.

### EXAMPLES

### Preparation of CeF₃:Er and CeF₃:Yb,Er Nanoparticles

Stoichiometric amounts of 99.5% cerium (III) nitrate, 99.9% erbium (III) nitrate, 99.9% ytterbium (III) nitrate and 98% ammonium fluoride (Sigma Aldrich, St. Louis, Mo.) were mixed in about 75 mL of water for 30 minutes. This mixture was next transferred to a 125 mL Teflon liner and heated to about 200° C. for 2 hours in a Parr pressure vessel (Parr Instrument Company, Moline, Ill.). The as-synthesized nanoparticles were washed three times in deionized water by centrifuging and dried at 70° C. in an oven (Thermo Scientific Thermolyne, Waltham, Mass.) for further powder characterization. Heat treatment of the as-synthesized particles was completed in a controlled environment using the double crucible method to prevent CeF₃ oxidation. 10 mL and 50 mL alumina crucibles (CoorsTek, Golden, Colo.) were used for the heat treatment. About 0.9 g of as-synthesized nanoparticles (inner 10 mL crucible) was heated with about 3.0 g of 95% ammonium bifluoride (outer 50 mL crucible) at about 400° C. for 1 hour in a box furnace.

Transmission electron microscopy (TEM) images of samples on 400-mesh carbon-coated copper grids (Electron Microscopy Sciences, Hatfield, Pa.) were taken using the JEOL 100CX transmission electron microscope (JEOL, Tokyo, Japan) equipped with a LaB₆ gun operating at an accelerating voltage of 80 kV. Powder x-ray diffraction (XRD) patterns were obtained with a resolution of 0.04°/step with the Siemens D500 (Bruker AXS Inc., Madison, Wis.) powder diffractometer (40 kV, 30 mA), using Cu K_{α} radiation (λ=1.54 Å). Powder diffraction files (PDF) from International Centre for Diffraction Data (ICDD, Newtown Square, Pa.) for CeF₃ PDF#97-000-0004 and YbF₃ PDF#97-000-9844 were used as references.

The emission spectra of nanoparticles excited at ˜976 nm with a 0.7 W laser (BW976, BW Tek, Newark, N.J.), was collected, focused and dispersed using a 0.55 m Triax 550 monochromator (Jobin Yvon, Edison, N.J.). The signals were detected with a thermoelectrically cooled InₓGa₁₋ₓAs detector (Electro-Optical Systems, Phoenixville, Pa.). A lock-in amplifier (SR850 DSP, Stanford Research System, Sunnyvale, Calif.) amplified the output signal from the detector. The spectrometer and detection systems were interfaced using a data acquisition system that was controlled with Synerjy commercial software (Jobin Yvon and Origin Lab Corporation). Radiative decay time of CeF₃:Er nanoparticles excited at 976 nm with a 0.7 W laser modulated at about 40 Hz, was measured using a digital storage oscilloscope (TDS 220, Tektronix, Richardson, Tex.).

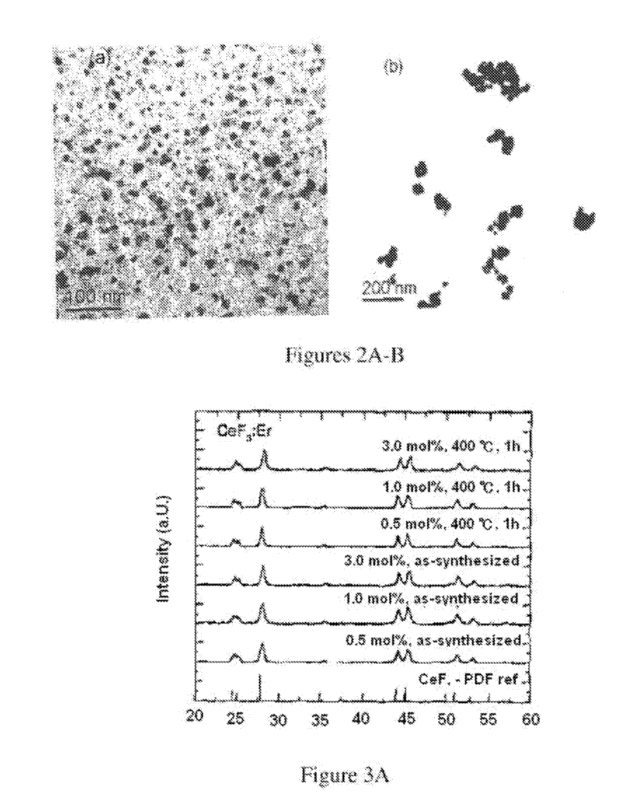

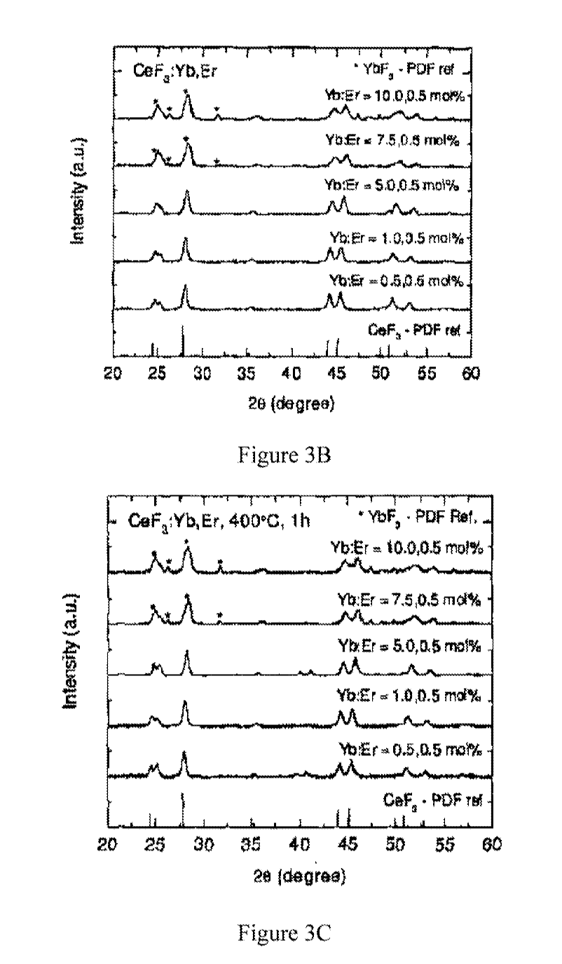

FIG. 2 is a TEM micrograph that shows that this process produced Er-doped CeF₃ nanoparticles with particle sizes of about 14±6 nm. After heat treatment, the particle size distribution increased to about 42±15 nm. Particle aggregation during heat treatment had resulted in the increase in particle size distribution. X-ray powder diffraction patterns of both as-synthesized and heat-treated particles confirmed the formation of hexaganol CeF₃ (FIG. 3). Further evaluation of the peak width using Scherrer's equation showed that the average sizes of as-synthesized and heat treated particles were about 13-17 nm and about 16-19 nm, respectively. Because particle and crystallite size were similar for as-synthesized CeF₃:Er particles, these data indicate that single nanocrystals were synthesized. In contrast, the difference in particle and crystallite size for heat treated CeF₃:Er showed that polycrystalline nanoparticle aggregates were obtained after heat treatment.

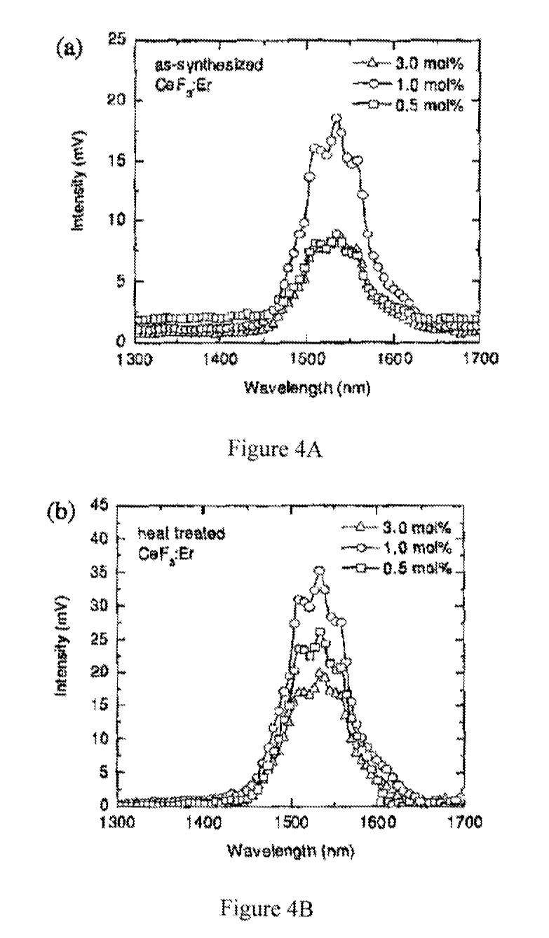

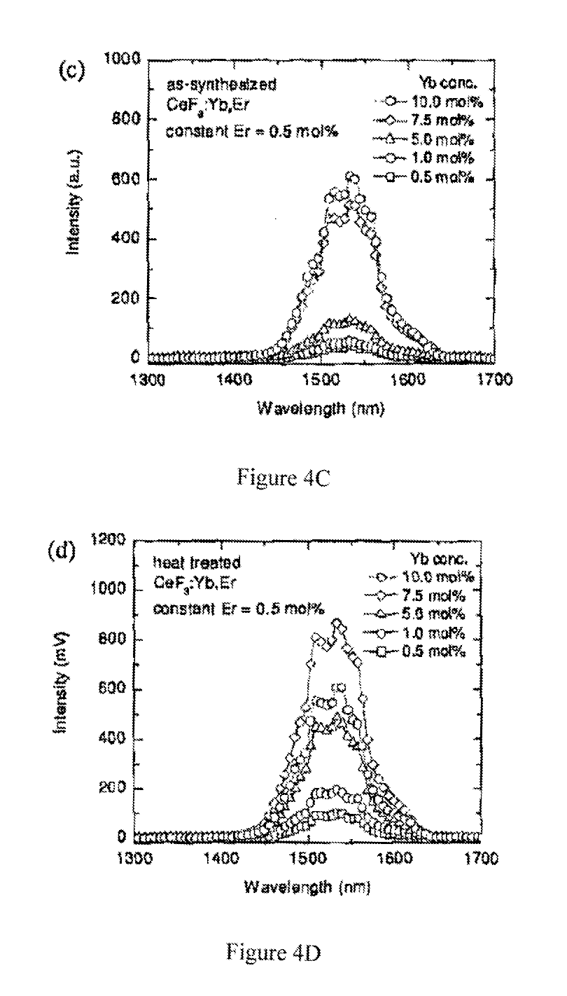

The emission spectra of as-synthesized and heat treated CeF₃:Er and CeF₃:Yb,Er upon excitation at about 975 nm are shown in FIG. 4(a) and (b), respectively. A broad near-infrared emission at about 1530 nm with no visible emissions was observed for all particles. The absence of visible emissions was consistent with the proposed scheme in FIG. 1(b), where phonon-assisted energy transfer between Er³⁺ and Ce³⁺ had eliminated upconversion losses by increasing population density of electrons to the Er^{3+ 4}I_{13/2} level. Considering that the cutoff phonon energy (hω) for CeF₃ was about 320 cm⁻¹ and energy difference of ΔE˜1486 cm⁻¹ between the ⁴I_{11/12}→⁴I_{13/2} transition of Er³⁺ (ΔE_{Er}˜3656 cm⁻¹) and ²F_{7/2}→²F_{5/2} transition of Ce³⁺ (ΔE_{Ce}˜2170 cm⁻¹), the estimated number of phonons (N) emitted in the non-radiative decay would be about 5 using N=ΔE/hω and assuming that the phonons involved in the energy transfer are of equal energy. The addition of Yb³⁺ co-dopant in CeF₃:Er further increased the emission intensity at about 1530 nm. Comparing the maximum intensities of CeF₃:Er and CeF₃:Yb,Er in FIG. 4(a) and FIG. 4(c), respectively, an intensity enhancement of about 25 times was achieved with the addition of Yb as a co-dopant. The improved emission intensity with addition of Yb³⁺ showed that the Yb³⁺—Er³⁺ interactions were strong, and the presence of energy transfer from Yb→Er that had further increased population density of the Er^{3+ 4}I_{13/2} level.

In addition, as shown in FIG. 4, emission intensities of CeF₃:Er and CeF₃:Yb,Er nanoparticles improve after heat treatment. The enhanced emission after heat treatment can be attributed to either enhanced Yb³⁺—Er³⁺—Ce³⁺ interactions from a more uniform rare earth distribution, or reduced emission quenching from reduction in concentration of lattice and surface defects. Possible particle defects that led to quenching of the emission include presence of surface and bulk hydroxyl groups and cation-anion vacancies. Because the surface-to-volume ratio increases with reducing particle size, the contribution of surface defects to optical properties increases.

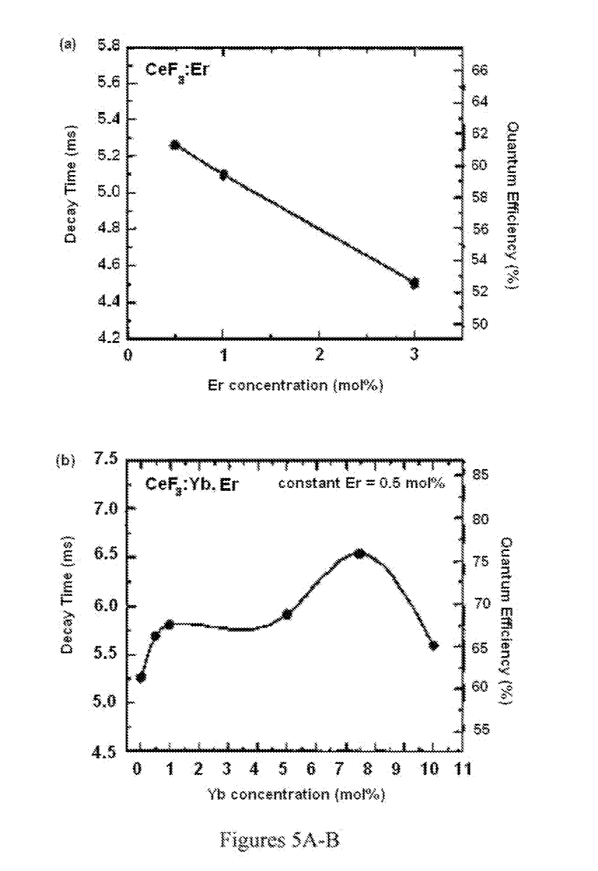

Further, the luminescence decay time and quantum efficiency of the about 1530 nm emission from heat treated CeF₃:Er and CeF₃:Yb,Er nanoparticles were measured, as shown in FIG. 5. The quantum efficiency was determined by taking the ratio of measured decay time with that of theoretically calculated decay time. The average measured luminescence lifetimes of the about 1530 nm emission for heat treated CeF₃:Er and CeF₃:Yb,Er nanoparticles was about 4.5-6.5 ms, with quantum efficiencies of about 52-75%. The low quantum efficiency of these materials can be attributed to non-radiative recombination losses from the presence of lattice and surface defects that remained after heat treatment. FIG. 5(a) shows that for heat treated CeF₃:Er, the luminescence decay time and quantum efficiency decreased linearly as Er concentration increased due to reducing Er—Er interatomic distance. FIG. 5(b) shows that for heat treated CeF₃:Yb,Er, the luminescence decay time and quantum efficiency increased with increasing Yb concentration up to about 7.5 mol %, as energy transfer efficiency from Yb→Er improved.

Amongst the differently doped compositions, the maximum emission intensity of about 870 mV (see FIG. 4(d)) and maximum measured luminescence lifetime of about 6.5 ms with a quantum efficiency of about 75% (see FIG. 5(b)), was observed for heat treated CeF₃:Yb,Er (7.5, 0.5 mol %) nanoparticles. This measured intensity and luminescence decay time for heat treated CeF₃:Yb,Er (7.5, 0.5 mol %) nanoparticles was comparable to that measured from a standard sample of Er-doped phosphate laser glass (Kigre Inc., Hilton Head Island, S.C.) of about 900 mV and about 8 ms, respectively. The decrease in emission intensity and quantum efficiency for heat-treated CeF₃:Yb,Er (10, 0.5 mol %) could be attributed to the phase separation of YbF₃. YbF₃ phase separation was observed for Yb≧7.5 mol %, as shown by the presence of orthorhombic YbF₃ peaks (see FIG. 3 (b) and (c)). As a consequence of YbF₃ phase separation, fewer Yb³⁺—Er³⁺ pairs exist for energy transfer leading to lower emission intensities and quantum efficiencies in CeF₃:Yb,Er (10, 0.5 mol %). Considering that YbF₃ (orthorhombic) and CeF₃ (hexagonal) are non-isostructural, Yb solubility in CeF₃ is limited to about 7.5 mol %. The limited solubility leads to Yb³⁺ ion clustering as the solubility limit approaches which induces concentration quenching. In addition, high concentration Yb doping could potentially induce lattice distortion and alter the rare-earth ion separation distance. Subsequently, this would lead to non-radiative losses that would affect the phosphor's quantum efficiency.

In summary, near-infrared emitting Er- and Yb,Er-doped CeF₃ nanoparticles were synthesized using hydrothermal methods. A broad and intense emission at ˜1530 nm with no other visible emissions was observed in the as-synthesized and heat-treated CeF₃ nanoparticles upon excitation at ˜975 nm. It was also observed that intensity of the ˜1530 nm emission was significantly improved by about 25 times with the addition of Yb in Er-doped CeF₃. The average measured luminescence lifetimes of the ˜1530 nm emission for heat treated CeF₃:Er and CeF₃:Yb,Er nanoparticles was about 4.5-6.5 ms, with quantum efficiencies up to about 52-75%. These nanoparticles offer a vast range of potential applications, which include optical amplifiers, waveguides and laser materials.

We claim:

1) A rare earth element composition comprising CeF₃ particles doped with one or more rare earth elements, wherein each rare earth element atom replaces a Ce atom in said composition.

2) The composition of claim 1, wherein the one or more rare earth elements are selected from the group consisting of Pr, Nd, Yb, and Er.

3) The composition of claim 1, wherein the rare earth element doping concentration is up to about 5 mole percent.

4) The composition of claim 1, wherein the rare earth element doping concentration is from about 0.5 to about 1 mole percent.

5) The composition of claim 2, further comprising sensitizer atoms, wherein up to 60 mole percent of the Ce atoms are replaced with said sensitizer atoms.

6) The composition of claim 5, wherein the sensitizer atoms consist of Yb.

7) The composition of claim 1, wherein the CeF₃ comprises a hexagonal structure.

8) The composition of claim 1, wherein the CeF₃ comprises a tetragonal structure.

9) The composition of claim 1, wherein the CeF₃ comprises an orthorhombic structure.

10) The composition of claim 1, wherein said particles consist essentially of particles having a crystallite size between about 2 nm and about 100 microns.

11) The composition of claim 1, wherein said particles consist essentially of particles having a crystallite size between about 5 nm and about 10 microns.

12) The composition of claim 1, wherein said particles consist essentially of particles having a crystallite size between about 10 nm and about 1 micron.

13) The composition of claim 1, wherein said particles consist essentially of particles having a crystallite size between about 10 nm and 500 nm.

14) The composition of claim 1, wherein said particles consist essentially of nanoparticles.

15) An optically transparent composite material comprising a dispersion in a polymeric matrix of the composition of claim 6.

16) The composite material of claim 7, wherein said matrix is a fluoropolymer.

17) A luminescent device comprising an optical element formed from the composite material of claim 7.

18) The luminescent device of claim 9, wherein said device is a zero-loss link, upconversion light source, standard light source, volumetric display, flat panel display, or a source operating in a wavelength-division-multiplexing scheme.

19) The luminescent device of claim 9, wherein said composite material comprises a plurality of rare earth element compositions that upon excitation, fluorescence or luminescence emit a plurality of overlapping emission bands.

20) The luminescent device of claim 9, wherein said composite material comprises a plurality of rare earth element compositions that upon excitation, fluorescence or luminescence emit a plurality of separate and distinct emission bands.
